(19) United States
(12) Patent Application Publication
(10) Pub. No.: US 2016/0125649 A1
(43) Pub. Date: May 5, 2016

(54) RENDERING APPARATUS AND RENDERING METHOD

(71) Applicant: SAMSUNG ELECTRONICS CO., LTD., Suwon-si (KR)

(72) Inventors: Minkyu JEONG, Yongin-si (KR); Haewoo PARK, Seoul (KR); Minyoung SON, Hwaseong-si (KR); Donghoon YOO, Suwon-si (KR)

(73) Assignee: SAMSUNG ELECTRONICS CO., LTD., Suwon-si (KR)

(21) Appl. No.: 14/722,435

(22) Filed: May 27, 2015

(30) Foreign Application Priority Data
Oct. 31, 2014 (KR) 10-2014-0150626

(51) Int. Cl. G06T 17/20; G06T 15/80; G06T 15/04; G06T 15/40; G06T 17/10

(52) U.S. Cl. CPC G06T 17/20; G06T 15/405; G06T 17/10; G06T 15/04; G06T 15/80; G06T 2200/04; G06T 2200/28

(57) ABSTRACT

Provided are a rendering method and a rendering apparatus, which perform tile-based rendering. The rendering method includes determining a visible fragment based on a depth test with respect to fragments included in a tile, storing an identifier of a primitive corresponding to the visible fragment, and performing selective rendering on a primitives included in the tile based on the identifier of the primitive. The rendering apparatus implements such a rendering method.

### CROSS-REFERENCE TO RELATED APPLICATION(S)

This application claims the benefit under 35 U.S.C. §119(a) of Korean Patent Application No. 10-2014-0150626 filed on Oct. 31, 2014, in the Korean Intellectual Property Office, the entire disclosure of which is incorporated herein by reference for all purposes.

### BACKGROUND

1. Field

The following description relates to a tile-based rendering apparatus and a tile-based rendering method.

2. Description of Related Art

Generally, three-dimensional (3D) rendering changes two-dimensional (2D) or 3D objects to a displayable 2D pixel expression. When rendering is performed on each frame, many operations are performed and a large amount of power is consumed. Also, when tessellation is performed during the rendering, more operations are performed and more power is consumed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Provided are a rendering apparatus and a rendering method, which perform tile-based rendering.

Additional examples are set forth in part in the description which follows and, in part, are apparent from the description, or are learned by practice of the presented examples.

In one general aspect, a rendering method of performing tile-based rendering includes determining a visible fragment based on a depth test with respect to fragments included in a tile, storing an identifier of a primitive corresponding to the visible fragment, and performing selective rendering on primitives included in the tile based on the identifier of the primitive.

The method may further include generating a primitive visibility stream indicating visibility information of the primitives based on the identifier of the primitive, and performing selective rendering on the primitives by using the primitive visibility stream.

The performing of the selective rendering may include performing rasterizing only on a primitive determined to be visible from among the primitives.

The method may further include dividing a frame into tiles and recognizing a primitive included in each of the tiles, wherein the primitive visibility stream is generated according to the tiles and indicates whether a primitive included in each of the tiles is visible.

The method may further include generating a patch visibility stream indicating visibility information of patches included in the tile based on the identifier of the primitive, and performing tessellation only on a patch determined to be visible from among the patches, by using the patch visibility stream.

The generating of the patch visibility stream may include obtaining an identifier of a patch corresponding to the primitive based on the identifier of the primitive, and generating the patch visibility stream based on the obtained identifier of the patch.

The method may further include generating a vertex visibility stream indicating visibility information of vertices included in the tile based on the identifier of the primitive, and performing shading only on a vertex determined to be visible from among the vertices by using the vertex visibility stream.

The storing may include, in response to one fragment of the fragments being visible, updating and storing an existing identifier as an identifier of a primitive corresponding to the one fragment.

The method may provide that, in response to the rendering method being continuously performed through a first pipeline and a second pipeline, the storing is performed in the first pipeline and the performing of the selective rendering is performed in the second pipeline.

Rendering performed in the first pipeline may be performed by using coordinate information of the fragments in the tile and coordinate information of the primitives in the tile.

In another general aspect, a rendering apparatus for performing tile-based rendering may include a test unit configured to determine a visible fragment based on a depth test with respect to fragments included in a tile, a primitive buffer configured to store an identifier of a primitive corresponding to the visible fragment, and a rendering unit configured to perform selective rendering on primitives included in the tile based on the identifier of the primitive.

The apparatus may further include a stream generator configured to generate a primitive visibility stream indicating visibility information of the primitives based on the identifier of the primitive, wherein the rendering unit performs selective rendering on the primitives by using the primitive visibility stream.

The rendering unit may perform rasterizing only on a primitive determined to be visible from among the primitives.

The rendering apparatus may further include a tile binning unit configured to divide a frame into tiles and recognizes a primitive included in each of the tiles, wherein the primitive visibility stream is generated according to the tiles and indicates whether a primitive included in each of the tiles is visible.

The rendering apparatus may further include a stream generator configured to generate a patch visibility stream indicating visibility information of patches included in the tile based on the identifier of the primitive, wherein the rendering unit includes a tessellation pipeline that performs tessellation only on a patch determined to be visible from among the patches, by using the patch visibility stream.

The stream generator may obtain an identifier of a patch corresponding to the primitive based on the identifier of the primitive and may generate the patch visibility stream based on the obtained identifier of the patch.

The rendering apparatus may further include a stream generator configured to generate a vertex visibility stream indicating visibility information of vertices included in the tile based on the identifier of the primitive, wherein the rendering unit includes a vertex shading unit that performs shading only on a vertex determined to be visible from among the vertices by using the vertex visibility stream.

In response to one fragment of the fragments being visible, an identifier pre-stored in the primitive buffer may be updated and stored as an identifier of a primitive corresponding to the one fragment.

In response to the rendering apparatus continuously performing rendering as a first pipeline and a second pipeline, the primitive buffer may store the identifier of the primitive corresponding to the visible fragment in the first pipeline, and the rendering unit may perform selective rendering on the primitives by using the identifier of the primitive in the second pipeline.

Rendering performed in the first pipeline may be performed by using coordinate information of the fragments in the tile and coordinate information of the primitives in the tile.

In another general aspect, a rendering method of performing tile-based rendering includes storing an identifier of a primitive corresponding to a fragment determined to be a visible fragment based on a depth test with respect to fragments included in a tile, and performing selective rendering on primitives included in the tile based on the identifier of the primitive.

Other features and aspects will be apparent from the following detailed description, the drawings, and the claims.

### BRIEF DESCRIPTION OF THE DRAWINGS

FIG. 1 is a diagram for describing a process of rendering a 3-dimensional (3D) image, which is performed by a rendering apparatus, according to an example.

FIG. 2 is a diagram for describing in detail, a tessellation pipeline that performs tessellation, according to an example.

FIG. 3 is a block diagram of a rendering apparatus according to an example.

FIG. 4 is a diagram for describing generating of a primitive visibility stream, according to an example.

FIG. 5 is a diagram for describing generating of a patch visibility stream and a vertex visibility stream, according to an example.

FIG. 6 is a block diagram of a rendering apparatus according to another example.

FIG. 7 is a diagram for describing a rendering method performed by the rendering apparatus of FIG. 6 through a pipeline, according to an example.

FIG. 8 is a flowchart of a rendering method performed by the rendering apparatus of FIG. 3, according to an example.

FIG. 9 is a block diagram of a rendering apparatus according to another example.

FIG. 10 is a diagram for describing a rendering method performed by the rendering apparatus of FIG. 9 through a pipeline, according to an example.

FIG. 11 is a block diagram of a device including a rendering apparatus, according to an example.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Reference is now made in detail to examples, examples of which are illustrated in the accompanying drawings, wherein like reference numerals refer to like elements throughout. In this regard, the present examples potentially have different forms and are not to be construed as being limited to the descriptions set forth herein. Accordingly, the examples are merely described below, by referring to the figures, to explain aspects.

All terms, including descriptive or technical terms which are used herein, are to be construed as having meanings that are apparent to one of ordinary skill in the art. However, the terms potentially have different meanings according to an intention of one of ordinary skill in the art, precedent cases, or the appearance of new technologies that indicate that the terms are to be interpreted in an appropriate different manner.

Also, when a part “includes” or “comprises” an element, unless there is a particular description contrary thereto, the part is able to further include other elements, not excluding the other elements. In the following description, terms such as “unit” and “module” indicate a unit for processing at least one function or operation, wherein the unit and the block are, in an example, potentially included in the example as appropriate hardware.

In the specification, when a region is “connected” to another region, the regions are not necessarily only “directly connected”, but are also possibly “electrically connected” via another device therebetween. Also, when a region “includes” an element, the region possibly further includes another element instead of excluding the other element, otherwise differently specified.

As used herein, the term “and/or” includes any and all combinations of one or more of the associated listed items.

Hereinafter, one or more examples are described in detail with reference to accompanying drawings.

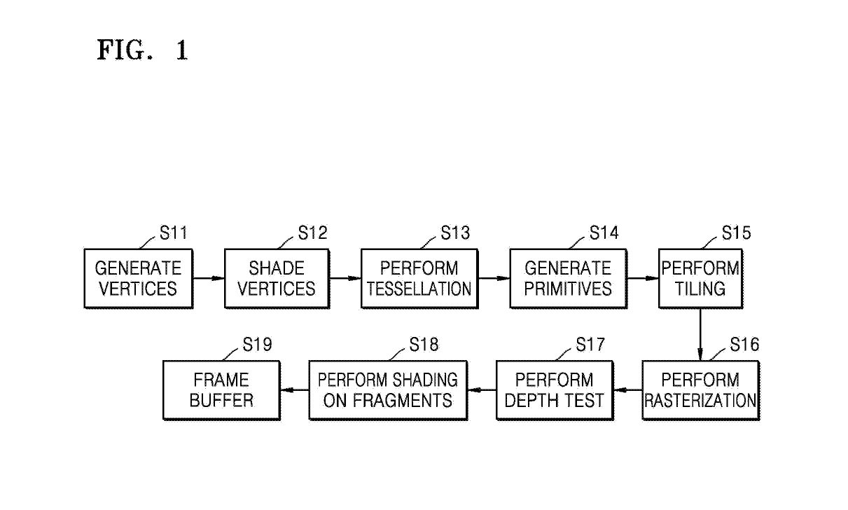

FIG. 1 is a diagram for describing a process of rendering a 3-dimensional (3D) image, which is performed by a rendering apparatus, according to an example.

Referring to FIG. 1, the process illustrated in the example of FIG. 1 includes operations S11 through S19.

In operation S11, the method generates vertices. In an example, the vertices are generated so as to indicate objects included in an image.

In operation S12, the method shades the generated vertices. In an example, a vertex shader performs shading on the vertices by assigning colors to the vertices generated in operation S11.

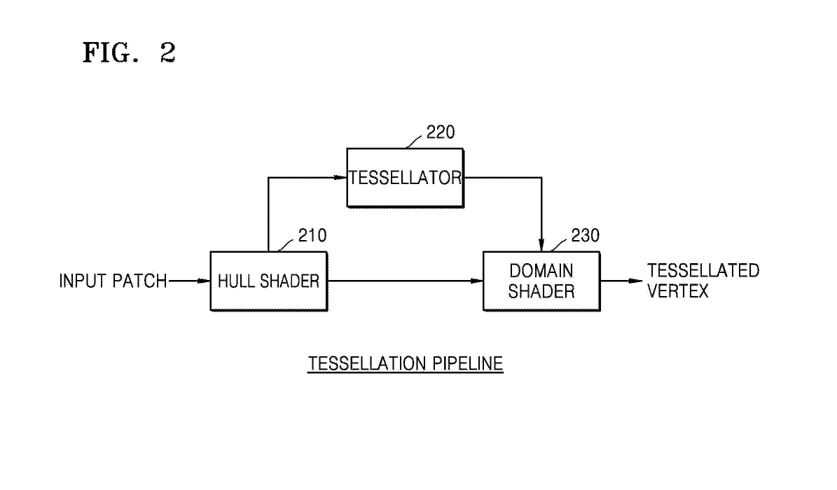

In operation S13, the method performs a tessellation based on the generated vertices. In an example, the tessellation is performed to generate more primitives than primitives generable through existing vertices, and generates more vertices than the existing vertices. Thus, the rendering apparatus expresses an image in more detail via tessellation and obtains a more realistic image. A tessellation pipeline that performs tessellation is described further later with reference to FIG. 2.

In operation S14, the method generates primitives. In an example, the primitives are polygons generated by points, lines, or vertices. In an example, the primitives are triangles generated by connecting vertices, where the vertices have been generated as discussed above.

In operation S15, the method performs tiling by dividing a frame being displayed on a screen into a plurality of tiles. In an example, the plurality of tiles are separately rendered and then combined later for display.

In operation S16, the method performs rasterization on the primitives. In an example, the rasterization is performed on the primitives by dividing each of the primitives into a plurality of fragments. A fragment is a unit for forming a primitive and is used as a basic unit for performing an image process. A primitive includes information about a vertex. Accordingly, interpolation is performed while generating fragments between vertices during the rasterization.

In operation S17, the method performs a depth test, also referred to as a z-test because depth is measured as the z coordinate of a pixel, on the generated fragments. In an example, a high throughput is required in order to perform shading or texturing on a fragment or a pixel. Thus, the depth test is performed so as to reduce a throughput by efficiently performing the shading or texturing.

In such an example, the depth test is performed by comparing a depth value of each input fragment with a depth value pre-stored in a depth buffer and corresponding to a location of each of the input fragments. When the depth value of each of the input fragments is less than the depth value pre-stored in the depth buffer, that is, when the input fragment is visible in a final output image, the depth test is performed by updating the depth value pre-stored in the depth buffer to the depth value of each of the input fragments. Accordingly, depth values of visible fragments are stored in the depth buffer as results of performing the depth test on all input fragments.

In operation S18, the method performs shading on the fragments. Also, in an example, the shading is performed in pixel units. For example, shading of a pixel or a fragment indicates that a color of the pixel or the fragment is assigned.

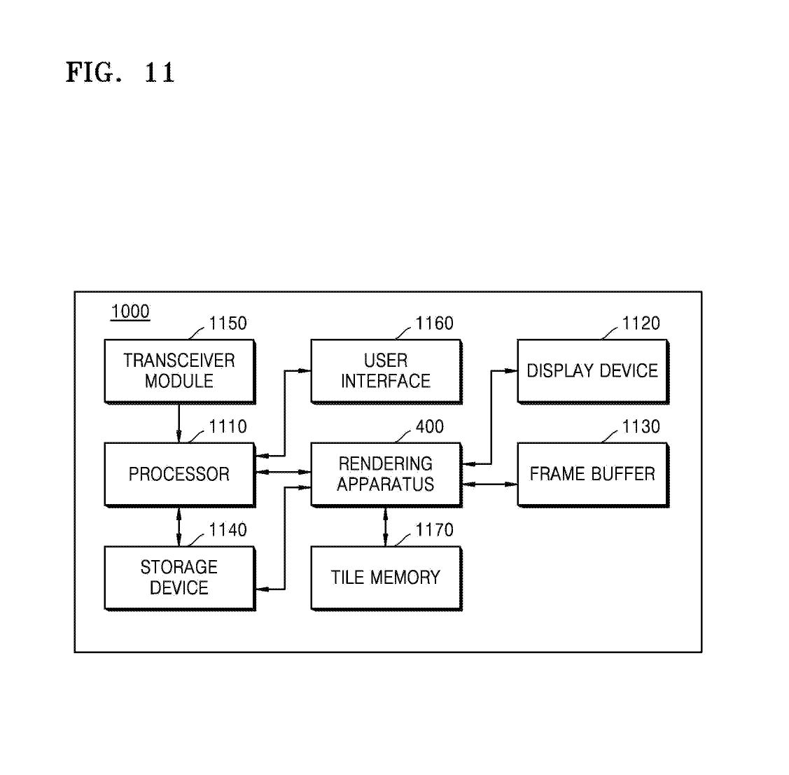

In operation S19, the method displays a frame stored in a frame buffer. In the example of FIG. 1, a frame generated by performing operations S11 through S18 is stored in the frame buffer. The frame stored in the frame buffer is displayed on a display device, for example, a display device 1120 of FIG. 11.

The rendering apparatus, according to a particular example, separately stores, in a buffer, an identifier (ID) of a primitive determined to be visible based on a depth test during rendering. Also, the rendering apparatus generates a primitive visibility stream by using the stored ID. Thus, the rendering apparatus performs selective rendering on the primitives by using the ID or the primitive visibility stream generated as discussed above, thereby reducing throughputs and bandwidths used during rendering. By reducing these amounts of data, examples are able to improve rendering performance.

FIG. 2 is a diagram for describing in detail, a tessellation pipeline that performs tessellation, according to an example.

In the example of FIG. 2, the tessellation pipeline includes a hull shader 210, a tessellator 220, and a domain shader 230. However, it is apparent to one of ordinary skill in the art that the tessellation pipeline optionally further includes general-purpose components other than those shown in FIG. 2. That is, the tessellation pipeline potentially includes other appropriate components in addition to or instead of the components illustrated in FIG. 2.

In the example of FIG. 2, the hull shader 210 receives an input patch from the vertex shader that performs operation S12 of FIG. 1, according to an example. According to such an example, the input patch is defined by input control points, wherein an input control point is a group of vertices and defines a surface of a low dimension. According to an example, the hull shader 210 generates output control points by deforming the input control points and transmits an output patch defined by the output control points to the domain shader 230. Also, according to an example, the hull shader 210 determines a tessellation level. According to an example, the tessellation level is a numerical value indicating the number of triangles, quadrilaterals, also known as quads, or isolines the input patch is to be divided into to form the tessellation. According to an example, the hull shader 210 transmits the determined tessellation level to the tessellator 220 and the domain shader 230.

In the example of FIG. 2, the tessellator 220 receives the tessellation level from the hull shader 210. According to an example, the tessellator 220 divides a region called a domain, according to the tessellation level. As discussed, such a tessellation level is determined by the hull shader 210. According to an example, the tessellator 220 divides the domain into a plurality of triangles according to the tessellation level. Also, the tessellator 220 calculates barycentric coordinates of the plurality of triangles from vertices forming each of the plurality of triangles. In such an example, the tessellator 220 transmits the barycentric coordinates to the domain shader 230.

According to an example, the domain shader 230 receives the output patch from the hull shader 210 and receives the barycentric coordinates from the tessellator 220. According to an example, the domain shader 230 generates a plurality of new vertices by using the output patch and the barycentric coordinates. Accordingly, in such an example, the domain shader 230 outputs tessellated vertices as the generated plurality of new vertices.

As described in the examples above, vertices output from a vertex shader are input, as an input patch, to a tessellation pipeline, and the tessellation pipeline outputs more vertices than those input to the tessellation pipeline via tessellation. Accordingly, more primitives are generated corresponding to the more vertices, and thus more throughput and more bandwidths of information are potentially required to process the additional information.

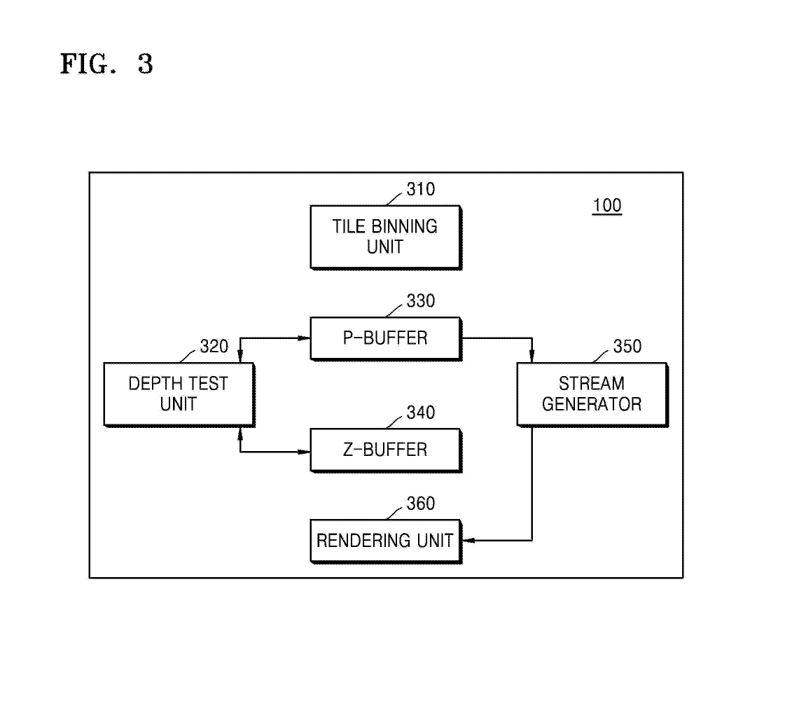

FIG. 3 is a block diagram of a rendering apparatus 100 according to an example.

However, FIG. 3 only illustrates components of the rendering apparatus 100 related to the current example. Thus, one of ordinary skill in the art would recognize that the rendering apparatus 100 optionally further includes general-purpose components other than those shown in FIG. 3, as additional or alternative components to those shown in FIG. 3.

Referring to the example of FIG. 3, the rendering apparatus 100 includes a tile binning unit 310, depth test unit 320, a primitive buffer (P-buffer) 330, a depth buffer (Z-buffer) 340, a stream generator 350, and a rendering unit 360.

The tile binning unit 310 divides a frame output in a rendering image into tiles having pre-set sizes. According to an example, the pre-set sizes of the tiles are the same or different from each other according to settings. For example, when the frame is an image that includes 800×600 pixels, the tile binning unit 310 divides the frame into an array of 10×10 tiles, wherein each tile includes an image that includes 80×60 pixels, which are pieces of the frame.

Also, according to an example, the tile binning unit 310 recognizes primitives included in each tile. In other words, the tile binning unit 310 obtains information about the primitives included in each tile. In examples, the information about the primitives includes, for example, information about an ID, a location, a color, and texture of each primitive. Also, in such an example, the tile binning unit 310 recognizes a vertex or a patch included in each tile and obtains information about the vertex or the patch.

The Z-buffer 340 stores a depth value of each pixel forming the frame.

The P-buffer 330 store an ID of a primitive per pixel forming the frame. According to an example, the P-buffer 330 stores an ID of a visible primitive per pixel. Here, being visible is intended to mean visible on an output image, and thus when a primitive is visible, a shape of the primitive is shown on an output image so that it will be visible.

According to an example, the depth test unit 320 compares a depth value of an input fragment with a depth value stored in the Z-buffer 340. According to an example, when the depth value of the input fragment is less than a depth value of a pixel corresponding to the input fragment, which is stored in the Z-buffer 340, the depth value of the pixel is updated to become the depth value of the input fragment. When the depth value of the input fragment is less than the depth value stored in the Z-buffer 340, the input fragment is shown closer on a screen than the pixel corresponding to the input fragment. Thus, when depth tests are performed on all fragments included in one frame or one tile, depth values stored in the Z-buffer 340 all become depth values of visible fragments. Here, visible is intended to mean visible on an output image, and a visible fragment is intended to mean that a shape of a fragment is shown on an output image.

Also, according to an example, whenever the depth value of the input fragment is updated in the Z-buffer 340, the depth test unit 320 updates an ID of a primitive, which is pre-stored in the P-buffer 330, to an ID of a primitive corresponding to the input fragment. In other words, when the depth value of the input fragment is less than the depth value of the pixel corresponding to the input fragment, an ID of a primitive of a pixel, which is stored in the P-buffer 330, is updated to take on the value of an ID of a primitive of the input fragment. Accordingly, when depth tests are performed on all fragments included in one frame or one tile, IDs of primitives stored in the P-buffer 330 finally include only IDs of visible primitives.

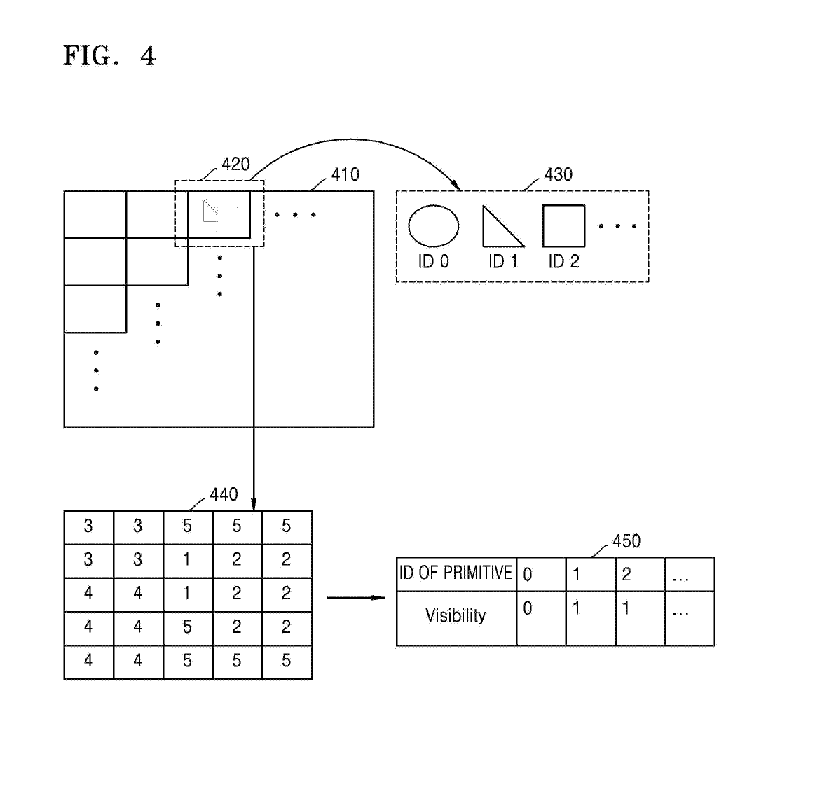

According to an example, the stream generator 350 generates a primitive visibility stream indicating visibility information of a primitive. The primitive visibility stream includes information about whether each of a plurality of primitives is visible. According to an example, the stream generator 350 generates a primitive visibility stream according to a plurality of tiles forming a frame, wherein the primitive visibility stream includes information about whether the primitive is visible. In such an example, a primitive visibility stream is generated such that an ID indicates 1 when a primitive is visible and an ID indicates 0 when a primitive is not visible, or vice versa, so that the information acts as a flag representing visibility. The generating of a primitive visibility stream is now described further with reference to FIG. 4.

FIG. 4 is a diagram for describing generating of a primitive visibility stream, according to an example.

In FIG. 4, a frame 410 includes a plurality of tiles, wherein a tile 420 of the plurality of tiles includes a plurality of primitives. According to an example, the frame 410 is divided into the plurality of tiles by the tile binning unit 310 of FIG. 3, wherein each of the plurality of tiles is analyzed to recognize primitives included therein. In FIG. 4, according to an example, a block 430 indicates that the tile 420 includes primitives having ID 0, ID 1, and ID 2. Meanwhile, in another example, the tile 420 includes primitives having other IDs, such as 3, 4, and 5, but the other IDs are omitted from being shown in the tile 420 and the block 430.

Referring to the example of FIG. 4, a primitive ID block 440 is an example of the P-buffer 330. According to an example, the P-buffer 330 includes the primitive ID block 440 corresponding to the tile 420, wherein the primitive ID block 440 includes an ID of a primitive visible at a location of each pixel of the tile 420, according to locations of pixels. In other words, when the tile 420 includes an array of 5×5 pixels, in the example, of FIG. 4, an ID of a primitive visible at a pixel located at a first row and a first column is 3 and an ID of a primitive visible at a pixel located at a second row and a third column is 1. Also, in such an example, the P-buffer 330 includes the primitive ID block 440 that is generated for each tile forming the frame 410.

Also, according to an example, the stream generator 350 of FIG. 3 generates a primitive visibility stream 450 corresponding to the tile 420 by using the primitive ID block 440 stored in the P-buffer 330. In other words, the stream generator 350 assigns a value of ‘1’ indicating visibility to IDs included in the primitive ID block 440 from among all IDs of the primitives included in the tile 420 and assign a value of ‘0’ indicating non-visibility to IDs not included in the primitive ID block 440 from among the all IDs of the primitives included in the tile 420. The stream generator 350 assigns such a value by using values of the IDs included in the primitive ID block 440. Thus, according to an example, the primitive visibility stream 450 of FIG. 4 indicates that ‘0’, that is, an index indicating visibility, is assigned to a primitive having an ID of 0, and that ‘1’, that is, an index indicating visibility, is assigned to a primitive having an ID of 1.

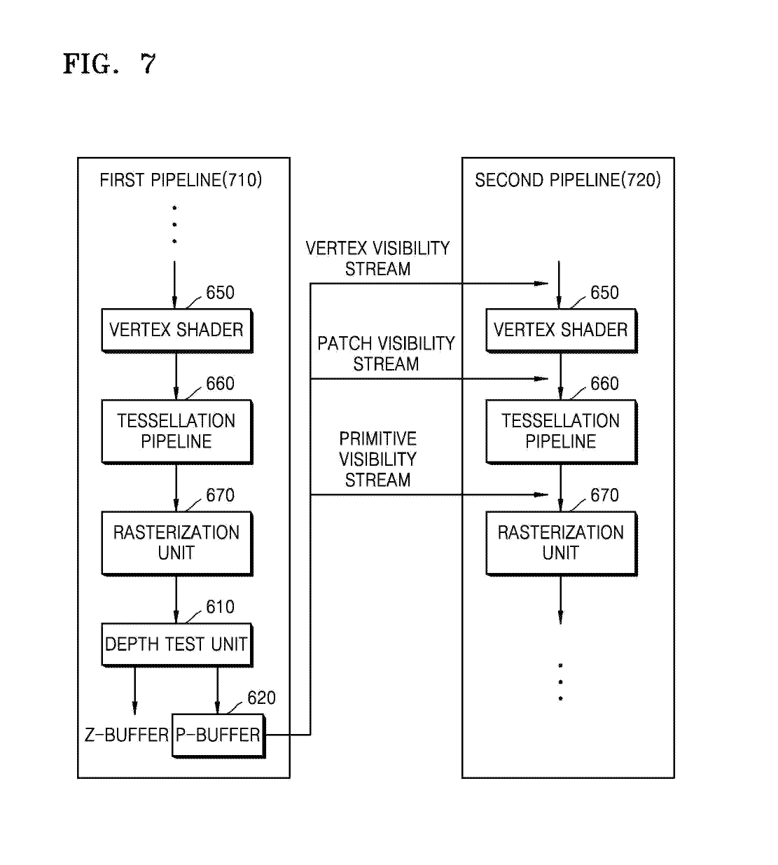

The stream generator 350 of FIG. 3 generates a vertex visibility stream indicating visibility information of a vertex corresponding to a primitive, according to an example. In such an example, the vertex visibility stream includes information about whether a vertex included in a tile is visible. According to an example, the stream generator 350 recognizes from which vertex a primitive is generated, based on a structure of the primitive. In other words, a structure of a primitive includes IDs of vertices forming the primitive, and thus the stream generator 350 obtains IDs of vertices corresponding to each primitive through a structure of each primitive included in a tile. Accordingly, the stream generator 350 generates a vertex visibility stream through an ID of each primitive stored in the P-buffer 330 and an ID of a vertex corresponding to each primitive. Also, according to an example, the stream generator 350 generates a vertex visibility stream through a generated primitive visibility stream and an ID of a vertex corresponding to a primitive included in the primitive visibility stream, as is described further below with reference to FIG. 7.

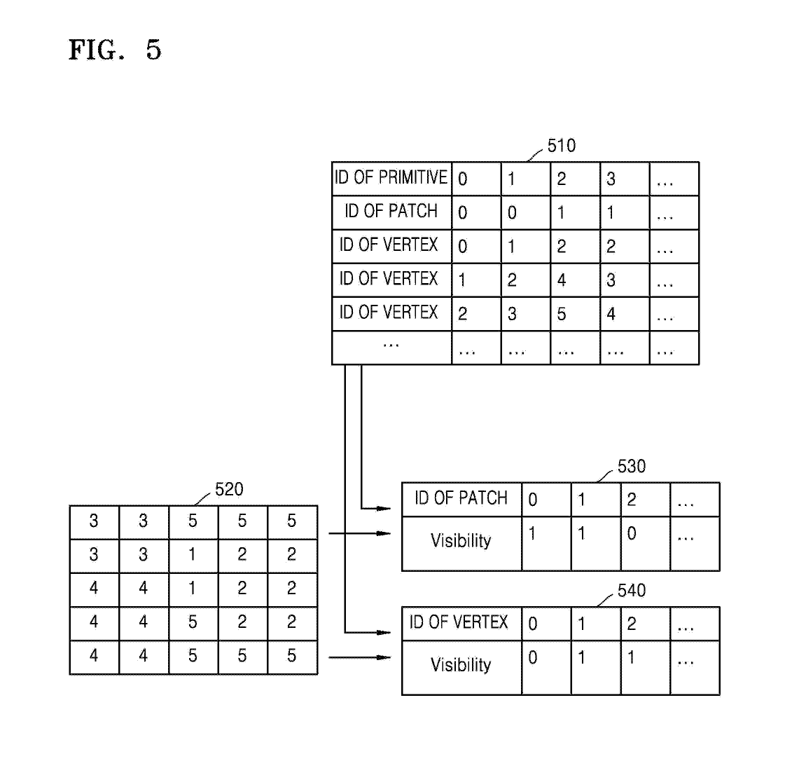

According to an example, the stream generator 350 of FIG. 3 generates a patch visibility stream indicating visibility information of a patch corresponding to a primitive. The patch visibility stream includes information about whether a patch included in a tile is visible. According to an example, the stream generator 350 recognizes from which patch a primitive is generated, based on a structure of the primitive. In other words, a structure of a primitive includes IDs of patches generating the primitive, and thus the stream generator 350 obtains IDs of patches corresponding to each primitive through a structure of each primitive included in a tile. Accordingly, the stream generator 350 generates a patch visibility stream through an ID of each primitive stored in the P-buffer 330 and an ID of a patch corresponding to the ID of each primitive. Also, according to an example, the stream generator 350 generates a vertex visibility stream through a generated primitive visibility stream and an ID of a vertex corresponding to a primitive included in the primitive visibility stream, as is described further now with reference to FIG. 5.

FIG. 5 is a diagram for describing generating of a patch visibility stream and a vertex visibility stream, according to an example.

Referring to the example of FIG. 5, a structure 510 of a primitive exists for each of a plurality of primitives included in a tile. The structure 510 includes information about a vertex or a patch related to the primitive, and for convenience of description, the structure 510 of FIG. 5 is shown in a form of a table. In other words, as shown in the structure 510, a primitive having ID 0 is generated from a patch having ID 0 and is generated from vertices having ID 0, ID 1, ID 2, and so on. Also, a primitive having ID 2 is generated from a patch having ID 1 and is generated from vertices having ID 2, ID 4, ID 5, and so on. Accordingly, in such an example, since a primitive is generated from a patch and vertices, the stream generator 350 obtains information about from which vertex the primitive is generated and from which patch the primitive is generated based on the structure 510, and generates a patch visibility stream and a vertex visibility stream. In other words, the stream generator 350 obtains visibility information about each primitive of the tile through a P-buffer and obtains an ID of a patch or an ID of a vertex, which corresponds to an ID of each primitive, through the structure 510. As a result, the stream generator 350 generates a patch visibility stream indicating visibility information according to IDs of patches included in the tile and vertex visibility stream indicating visibility information according to IDs of vertices included in the tile.

Referring to FIG. 5, according to an example, the stream generator 350 generates the patch visibility stream 530 through the structure 510 and a P-buffer 520, or alternatively is a primitive ID block included in the P-buffer 520. In the example of FIG. 5, the stream generator 350 obtains information indicating that a primitive having ID 0 is not visible but a primitive having ID 1 is visible, and information indicating that a patch having ID 0 corresponds to both of the primitives having ID 0 and ID 1 and since the primitive having ID 1 is visible, the patch having ID 0 is also visible, through the P-buffer 520.

Also, referring to FIG. 5, according to an example, the stream generator 350 generates a vertex visibility stream 540 through the structure 510 and the P-buffer 520. In this example, since a vertex having ID 1 corresponds to both of the primitives having ID 0 and ID 1 and the primitive having ID 1 is visible, the vertex having ID 1 is also visible.

The stream generator 350 of FIG. 3 generates a primitive visibility stream and transmits the primitive visibility stream to the rendering unit 360, according to an example. Also, according to an example, the stream generator 350 generates a vertex visibility stream or a patch visibility stream and transmits the vertex visibility stream or the patch visibility stream to the rendering unit 360.

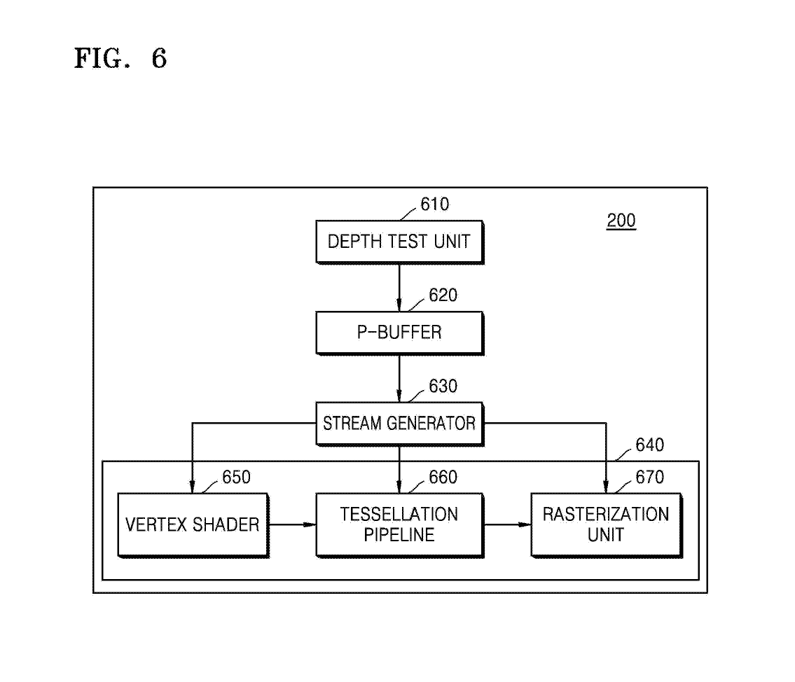

The rendering unit 360 of FIG. 3 performs selective rendering on a plurality of primitives included in a tile, based on an ID of a primitive stored in the P-buffer 330. According to an example, the rendering unit 360 performs selective rendering on a plurality of primitives included in a primitive visibility stream received from the stream generator 350. Also, according to an example, the rendering unit 360 performs selective rendering on a plurality of patches included in a patch visibility stream received from the stream generator 350. Also, according to an example, the rendering unit 360 performs selective rendering on a plurality of vertices included in a vertex visibility stream received from the stream generator 350. The selective rendering is now described further with reference to FIG. 6.

FIG. 6 is a block diagram of a rendering apparatus 200 according to another example.

In the example of FIG. 6, the rendering apparatus 200 includes a depth test unit 610, a P-buffer 620, a stream generator 630, and a rendering unit 640. However, it is apparent that the rendering apparatus 200 optionally further includes general-purpose components other than those shown in FIG. 6. Since the depth test unit 610, the P-buffer 620, and the stream generator 630 are similar to those described above with reference to FIG. 3, details thereof are not provided again.

According to the example of FIG. 6, the rendering unit 640 includes a vertex shader 650, a tessellation pipeline 660, and a rasterization unit 670.

According to an example, the vertex shader 650 performs shading on input vertices. Also, according to such an example, the vertex shader 650 receives a vertex visibility stream from the stream generator 630. Accordingly, according to such an example, the vertex shader 650 does not perform shading on vertices that are determined to be not visible based on the vertex visibility stream, from among the input vertices. In other words, according to such an example, the vertex shader 650 performs shading only on vertices that are determined to be visible based on a vertex visibility stream, from among vertices included in one of a plurality of tiles forming a frame.

According to an example, the tessellation pipeline 660 performs tessellation on an input patch transmitted by the vertex shader 650. Tessellation is described above further with reference to FIG. 2. According to an example, the tessellation pipeline 660 receives a patch visibility stream from the stream generator 630. Accordingly, the tessellation pipeline 660 does not perform tessellation on a patch that is determined to be not visible based on the patch visibility stream, from among input patches. In other words, the tessellation pipeline 660 performs tessellation only on patches determined to be visible based on a patch visibility stream, from among the patches included in one of a plurality of tiles forming a frame. In detail, a hull shader, not shown, included in the tessellation pipeline 660 generates an output patch only for patches determined to be visible based on a patch visibility stream, from among input patches, transmits the output patch to a domain shader, not shown, and determines a tessellation level only for the patches determined to be visible.

According to an example, the rasterization unit 670 performs rasterization on input primitives. Also, according to an example, the rasterization unit 670 receives a primitive visibility stream from the stream generator 630. Accordingly, in such an example, the rasterization unit 670 does not perform rasterization on primitives that are determined to be not visible based on the primitive visibility stream, from among input primitives. In other words, the rasterization unit 670 performs rasterization only on primitives determined to be visible based on a primitive visibility stream, from among primitives included in one of a plurality of tiles forming a frame.

As such, the rendering apparatus 200 uses a visibility stream to reduce throughputs and bandwidths for rendering processes performed on vertices, patches, and primitives.

FIG. 7 is a diagram for describing a rendering method performed by the rendering apparatus 200 of FIG. 6 through a pipeline, according to an example.

According to the example of FIG. 7, the vertex shader 650, the tessellation pipeline 660, the rasterization unit 670, and the depth test unit 610 of the rendering apparatus 200 are configured as pipelines. Thus, in the rendering method according to the current example, as illustrated in FIG. 7, rendering is continuously performed twice, thus providing for two-pass rendering, wherein the rendering apparatus 200 continuously performs rendering using a first pipeline 710 and a second pipeline 720.

In the first pipeline 710, the vertex shader 650 performs shading on a vertex by only using a location value of the vertex, the tessellation pipeline 660 performs tessellation by only using a location value of a patch, and the rasterization unit 670 performs rasterization by only using a location value of a primitive. Also, in the first pipeline 710, the depth test unit 610 determines a visible fragment via a depth test, and the P-buffer 620 stores an ID of a primitive corresponding to the visible fragment. Also, the stream generator 630 generates a primitive visibility stream, a patch visibility stream, and a vertex visibility stream based on the ID of the primitive stored in the P-buffer 620.

In the second pipeline 720, the vertex shader 650 does not perform shading on vertices that are determined to be not visible, based on the generated vertex visibility stream. In other words, the vertex shader 650 performs shading on vertices determined to be visible based on the generated vertex visibility stream. Also, the tessellation pipeline 660 does not perform tessellation on patches determined to be not visible based on the generated patch visibility stream. In other words, the tessellation pipeline 660 performs tessellation only on patches determined to be visible based on the generated patch visibility stream. Also, the rasterization unit 670 does not perform rasterization on primitives determined to be not visible based on the generated primitive visibility stream. In other words, the rasterization unit 670 performs rasterization only on primitives determined to be visible based on the generated primitive visibility stream.

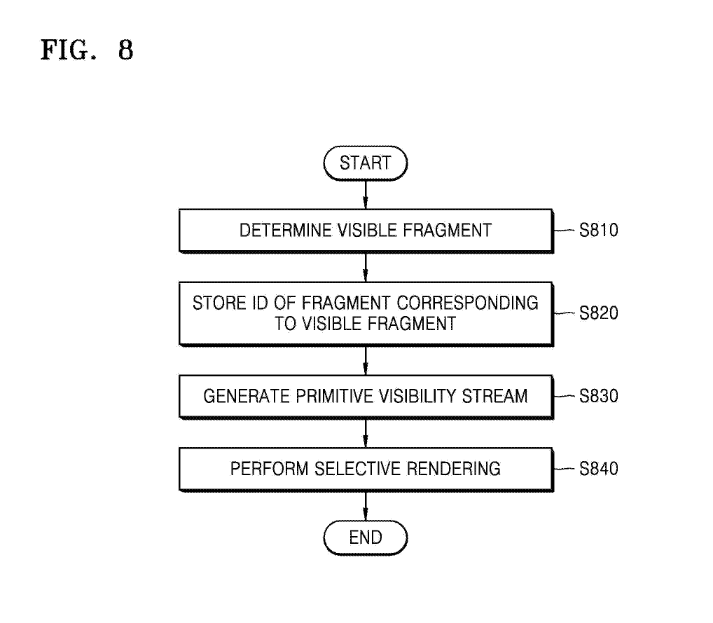

FIG. 8 is a flowchart of a rendering method performed by the rendering apparatus 100 of FIG. 3, according to an example.

In operation S810, the method determines a visible fragment based on a depth test performed on a plurality of fragments included in a tile. For example, the rendering apparatus 100 determines a visible fragment based on a depth test performed on a plurality of fragments included in a tile. Also, the rendering apparatus 100 divides a frame into a plurality of tiles and recognizes a primitive included in each of the plurality of tiles or a fragment generated from the primitive. Further, the depth test unit 320 included in the rendering apparatus 100 compares a depth value of each of a plurality of fragments included in a tile and a depth value stored in the Z-buffer 340. Then, when a depth value of one fragment of a plurality of fragments is less than a depth value of a pixel corresponding to the one fragment, which is stored in the Z-buffer 340, the depth test unit 320 updates the depth value of the pixel stored in the Z-buffer 340 to take on the depth value of the one fragment. Thus, when depth tests are performed on all fragments included in one tile, depth values stored in the Z-buffer 340 all assume depth values of visible fragments.

In operation S820, the method stores an ID of a primitive corresponding to a visible fragment. For example, the rendering apparatus 100 stores an ID of a primitive corresponding to a visible fragment. In other words, the rendering apparatus 100 stores an ID of a primitive corresponding to a visible fragment in the P-buffer 330 based on a result of performing a depth test on a depth value of each of a plurality of fragments included in a tile. Also, the depth test unit 320 updates an ID of a primitive, which is pre-stored in the P-buffer 330, to take on the value of an ID of a primitive corresponding to one fragment whenever a depth value of the one fragment from among the plurality of fragments is updated in the Z-buffer 340. As such, when depth tests are performed on all fragments included in one frame or one tile, IDs of primitives stored in the P-buffer 330 only include IDs of visible primitives.

In operation S830, the method generates a primitive visibility stream. For example, the rendering apparatus 100 generates a primitive visibility stream indicating visibility information of each of a plurality of primitives included in the tile based on the IDs of the primitives stored in the P-buffer 330. In an example, the stream generator 350 included in the rendering apparatus 100 generates a primitive visibility stream indicating whether a primitive included in each of a plurality of tiles is visible according to the plurality of tiles forming a frame. Also, in such an example, the stream generator 350 generates a vertex visibility stream indicating visibility information of a vertex corresponding to a primitive. According to an example, the stream generator 350 recognizes from which vertex a primitive is generated based on a structure of the primitive, and recognizes an ID of the vertex for generating the primitive. Accordingly, the stream generator 350 generates a vertex visibility stream by using an ID of each primitive stored in the P-buffer 330 and an ID of a vertex corresponding to each primitive. Also, the stream generator 350 generates a patch visibility stream indicating visibility information of a patch corresponding to a primitive. According to an example, the stream generator 350 recognizes from which patch a primitive is generated based on a structure of the primitive, and also recognizes an ID of a patch for generating a primitive. Accordingly, the stream generator 350 generates a patch visibility stream by using an ID of each primitive stored in the P-buffer 330 and an ID of a patch corresponding to the each primitive.

In operation S840, the method performs selective rendering. For example, the rendering apparatus 100 performs selective rendering on the plurality of primitives included in the tile based on the IDs of the primitives stored in the P-buffer 330. According to an example, the rendering apparatus 100 performs selective rendering on a plurality of primitives included in a tile by using a primitive visibility stream. In such an example, the rendering unit 360 included in the rendering apparatus 100 performs selective rendering on a plurality of primitives included in a primitive visibility stream received from the stream generator 350. Thus, the rendering unit 360 performs rasterizing only on a visible primitive from among a plurality of primitives by using a primitive visibility stream. Also, in such an example, the rendering apparatus 100 performs selective rendering on a plurality of patches included in a tile by using patch visibility stream. Thus, the rendering unit 360 performs tessellation only on a visible patch from among a plurality of patches by using a patch visibility stream. Also, the rendering apparatus 100 performs selective rendering on a plurality of vertices included in a tile by using a vertex visibility stream. In other words, the rendering unit 360 performs shading only on a visible vertex from among a plurality of vertices by using a vertex visibility stream.

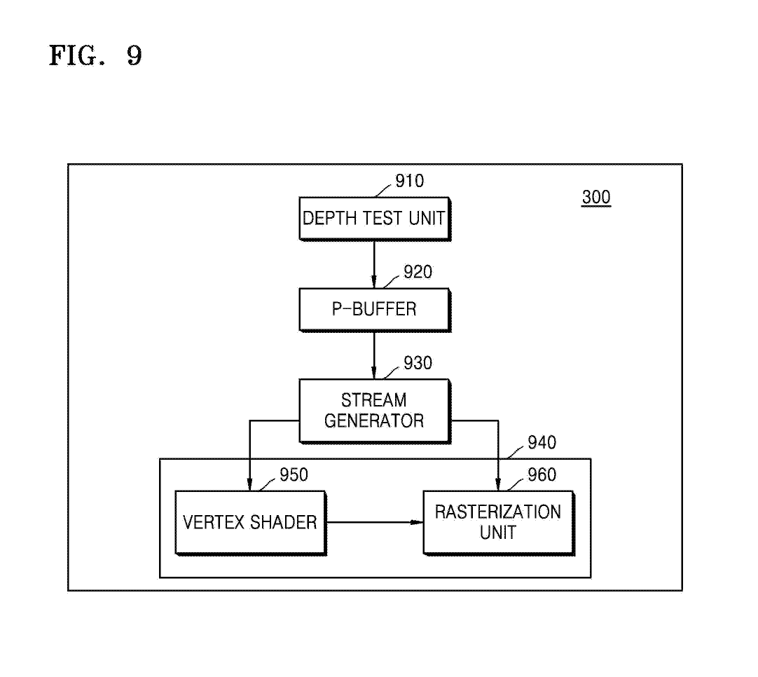

FIG. 9 is a block diagram of a rendering apparatus 300 according to another example.

In the example of FIG. 9, the rendering apparatus 300 includes a depth test unit 910, a P-buffer 920, a stream generator 830, and a rendering unit 940. However, the rendering apparatus 300 optionally further includes appropriate general-purpose components other than those shown in FIG. 9, in addition to or as replacements for these components. Since the depth test unit 910, the P-buffer 920, and the stream generator 930 are same as those described above with reference to FIG. 3, details thereof are not provided again, for brevity.

According to the example of FIG. 9, the rendering unit 940 includes a vertex shader 950 and a rasterization unit 960.

According to an example, the vertex shader 950 performs shading on input vertices. Also, according to an example, the vertex shader 950 receives a vertex visibility stream from the stream generator 930. Accordingly, in such an example, the vertex shader 950 does not perform shading on vertices determined to be not visible based on the vertex visibility stream, from among the input vertices. Thus, in such an example, the vertex shader 950 performs shading only on vertices determined to be visible based on a vertex visibility stream from among vertices included in one of a plurality of tiles forming a frame.

According to an example, the rasterization unit 960 performs rasterization on input primitives. Also, according to an example, the rasterization unit 960 receives a primitive visibility stream from the stream generator 930. Accordingly, in such an example, the rasterization unit 960 does not perform rasterization on primitives determined to be not visible based on the primitive visibility stream, from among the input primitives. Thus, the rasterization unit 960 performs rasterization only on primitives determined to be visible based on a primitive visibility stream, from among primitives included in one of a plurality of tiles forming a frame.

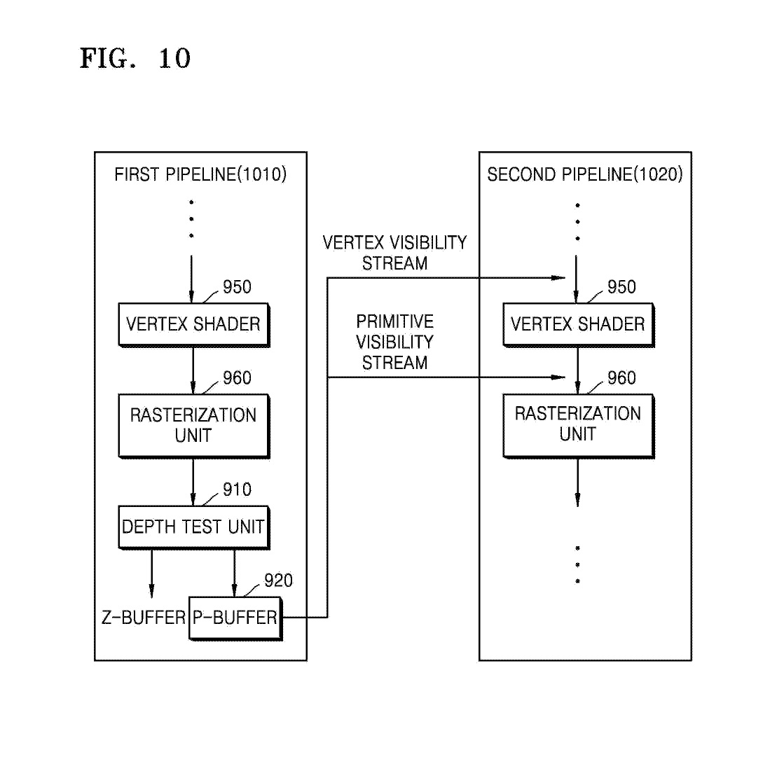

FIG. 10 is a diagram for describing a rendering method performed by the rendering apparatus 300 of FIG. 9 through a pipeline, according to an example.

According to the example of FIG. 10, the vertex shader 950, the rasterization unit 960, and the depth test unit 910 of the rendering apparatus 300 are configured as pipelines. Thus, in the rendering method according to the current examples, rendering is continuously performed twice, using 2-pass rendering, such that the rendering apparatus 300 continuously performs rendering as a first pipeline 1010 and a second pipeline 1020.

In the first pipeline 1010, the vertex shader 950 performs shading on a vertex by only using a location value of the vertex, and the rasterization unit 960 performs rasterization by only using a location value of a primitive. Also, in the first pipeline 1010, the depth test unit 910 determines a visible fragment via a depth test, and the P-buffer 920 stores an ID of a primitive corresponding to the visible fragment. Also, the stream generator 930 generates a primitive visibility stream and a vertex visibility stream based on the ID of the primitive stored in the P-buffer 920.

In the second pipeline 1020, the vertex shader 950 does not perform shading on vertices that are determined to be not visible, based on a pre-generated vertex visibility stream. Thus, the vertex shader 950 performs shading on vertices determined to be visible based on the pre-generated vertex visibility stream. Also, the rasterization unit 960 does not perform rasterization on primitives determined to be not visible based on a pre-generated primitive visibility stream. Thus, the rasterization unit 960 performs rasterization only on primitives determined to be visible based on the pre-generated primitive visibility stream.

FIG. 11 is a block diagram of a device 1000 including a rendering apparatus 400, according to an example. Examples of the device 1000 include a wireless device, a mobile phone, a personal digital assistant (PDA), a portable media player, a video game console, a mobile video conference unit, a laptop, a desktop, a television settop box, a tablet computing device, and an e-book reader, but are not limited thereto. According to the example of FIG. 11, the device 1000 includes a processor 1110, the rendering apparatus 400, the display device 1120, a frame buffer 1130, a storage device 1140, a transceiver module 1150, a user interface 1160, and a tile memory 1170. The device 1000 optionally further includes appropriate general-purpose components in addition to or as replacements for those shown in FIG. 11. Also, the components shown in FIG. 1 are optionally disposed outside the device 1000.

The rendering apparatus 400 is, in examples, any one of the rendering apparatus 100 of FIG. 3, the rendering apparatus 200 of FIG. 6, and the rendering apparatus 300 of FIG. 9, and thus details thereof are not provided again for brevity.

The processor 1110 executes at least one application. An application is a computer program that includes a series of instructions to cause the processor 1110 to perform a task. Examples of an application include a web browser, an e-mail application, a spreadsheet, a video game, and other applications generating visible objects for display. In the example of FIG. 11, the at least one application is stored in the storage device 1140. Also, according to an example, the processor 1110 downloads at least one application from the Internet or another network through the transceiver module 1150. Also, the processor 1110 executes at least one application based on a user's selection through the user interface 1160. Also, according to an example, the processor 1110 executes at least one application without interaction with a user.

Examples of the processor 1110 include a digital signal processor (DSP), a general-purpose processor, an application-specific integrated circuit (ASIC), a field-programmable gate array (FPGA), and other equivalent integrated or discrete logic circuits, but examples of the processor 1110 are not limited thereto.

The storage device 1140 includes at least one computer-readable storage medium. Examples of the storage device 1140 include a random access memory (RAM), a read only memory (ROM), an electrically erasable and programmable read only memory (EEPROM), a CD-ROM, a Blu-ray, other optical disk storage devices, magnetic disk storage devices, a flash memory, and other arbitrary media accessible by a computer or a processor. According to an example, the storage device 1140 may store commands enabling the processor 1110 or the rendering apparatus 400 to perform functions of the processor 1110 or the rendering apparatus 400.

According to an example, the storage device 1140 is a non-transitory storage medium. Here, ‘non-transitory’ may mean that a storage medium is not embodied in carrier waves or radio signals. However, ‘non-transitory’ should not be interpreted such that the storage device 1140 is non-movable. According to an example, the storage device 1140 may be included in a device other than the device 1000. Also, a storage device similar to the storage device 1140 is optionally inserted into the device 1000. According to an example, a non-transitory storage medium, such as an RAM, may store data that potentially, over time, changes.

Examples of the user interface 1160 include a track ball, a mouse, a keyboard, a game controller, and other types of input devices, but are not limited thereto. In an example, the user interface 1160 is a touch screen, and is embedded in the device 1000 as a part of the device 1000.

For example, the transceiver module 1150 includes a circuit unit that enables wireless or wired communication between the device 1000 and another device or a network. In such an example, the transceiver module 1150 includes modulators, demodulators, amplifiers, and other circuit units for wired or wireless communication.

According to an example, the tile memory 1170 stores tiles having pre-set sizes and obtained by the tile binning unit 310 of FIG. 3. Also, according to an example, the tile memory 1170 stores information about primitives included in each tile. The information about primitives may include information about an ID, a location, a color, and texture of each primitive. According to an example, the tile memory 1170 is formed as a part of the storage device 1140 or is disposed inside the rendering apparatus 400.

According to an example, the frame buffer 1130 stores an image frame rendered by the rendering apparatus 400.

According to an example, the display device 1120 displays a frame stored in the frame buffer 1130 on the display device 1120.

The particular examples shown and described herein are illustrative examples of the invention and are not intended to otherwise limit the scope of the examples in any way. For the sake of brevity, conventional electronics, control systems, software algorithms and other functional aspects of the systems and components of the individual operating components of the systems are not described in detail. Furthermore, the connecting lines, or connectors shown in the various figures presented are intended to represent exemplary functional relationships and/or physical or logical couplings between the various elements. It is intended to be noted that many alternative or additional functional relationships, physical connections or logical connections may be present in a practical device.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of one or more examples.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such as parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blu-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rendering method of performing tile-based rendering, the rendering method comprising:
determining a visible fragment based on a depth test with respect to fragments included in a tile;
storing an identifier of a primitive corresponding to the visible fragment; and
performing selective rendering on primitives included in the tile based on the identifier of the primitive.

2. The rendering method of claim 1, further comprising:
generating a primitive visibility stream indicating visibility information of the primitives based on the identifier of the primitive; and
performing selective rendering on the primitives by using the primitive visibility stream.

3. The rendering method of claim 2, wherein the performing of the selective rendering comprises performing rasterizing only on a primitive determined to be visible from among the primitives.

4. The rendering method of claim 2, further comprising dividing a frame into tiles and recognizing a primitive included in each of the tiles,
wherein the primitive visibility stream is generated according to the tiles and indicates whether a primitive included in each of the tiles is visible.

5. The rendering method of claim 1, further comprising:
generating a patch visibility stream indicating visibility information of patches included in the tile based on the identifier of the primitive; and
performing tessellation only on a patch determined to be visible from among the patches, by using the patch visibility stream.

6. The rendering method of claim 5, wherein the generating of the patch visibility stream comprises:
obtaining an identifier of a patch corresponding to the primitive based on the identifier of the primitive; and
generating the patch visibility stream based on the obtained identifier of the patch.

7. The rendering method of claim 1, further comprising:
generating a vertex visibility stream indicating visibility information of vertices included in the tile based on the identifier of the primitive; and
performing shading only on a vertex determined to be visible from among the vertices by using the vertex visibility stream.

8. The rendering method of claim 1, wherein the storing comprises, in response to one fragment of the fragments being visible, updating and storing an existing identifier as an identifier of a primitive corresponding to the one fragment.

9. The rendering method of claim 1, wherein, in response to the rendering method being continuously performed through a first pipeline and a second pipeline, the storing is performed in the first pipeline and the performing of the selective rendering is performed in the second pipeline.

10. The rendering method of claim 1, wherein rendering performed in the first pipeline is performed by using coordinate information of the fragments in the tile and coordinate information of the primitives in the tile.

11. A rendering apparatus for performing tile-based rendering, the rendering apparatus comprising:
a test unit configured to determine a visible fragment based on a depth test with respect to fragments included in a tile;
a primitive buffer configured to store an identifier of a primitive corresponding to the visible fragment; and
a rendering unit configured to perform selective rendering on primitives included in the tile based on the identifier of the primitive.

12. The rendering apparatus of claim 11, further comprising a stream generator configured to generate a primitive visibility stream indicating visibility information of the primitives based on the identifier of the primitive,
wherein the rendering unit performs selective rendering on the primitives by using the primitive visibility stream.

13. The rendering apparatus of claim 12, wherein the rendering unit performs rasterizing only on a primitive determined to be visible from among the primitives.

14. The rendering apparatus of claim 12, further comprising a tile binning unit configured to divide a frame into tiles and recognizes a primitive included in each of the tiles,
wherein the primitive visibility stream is generated according to the tiles and indicates whether a primitive included in each of the tiles is visible.

15. The rendering apparatus of claim 11, further comprising a stream generator configured to generate a patch visibility stream indicating visibility information of patches included in the tile based on the identifier of the primitive,
wherein the rendering unit comprises a tessellation pipeline that performs tessellation only on a patch determined to be visible from among the patches, by using the patch visibility stream.

16. The rendering apparatus of claim 15, wherein the stream generator obtains an identifier of a patch corresponding to the primitive based on the identifier of the primitive and generates the patch visibility stream based on the obtained identifier of the patch.

17. The rendering apparatus of claim 11, further comprising a stream generator configured to generate a vertex visibility stream indicating visibility information of vertices included in the tile based on the identifier of the primitive,
wherein the rendering unit comprises a vertex shading unit that performs shading only on a vertex determined to be visible from among the vertices by using the vertex visibility stream.

18. The rendering apparatus of claim 11, wherein, in response to one fragment of the fragments being visible, an identifier pre-stored in the primitive buffer is updated and stored as an identifier of a primitive corresponding to the one fragment.

19. The rendering apparatus of claim 11, wherein, in response to the rendering apparatus continuously performing rendering as a first pipeline and a second pipeline, the primitive buffer stores the identifier of the primitive corresponding to the visible fragment in the first pipeline, and the rendering unit performs selective rendering on the primitives by using the identifier of the primitive in the second pipeline.

20. The rendering apparatus of claim 19, wherein rendering performed in the first pipeline is performed by using coordinate information of the fragments in the tile and coordinate information of the primitives in the tile.
